(19) United States
(12) Patent Application Publication
(10) Pub. No.: US 2026/0043291 A1
(43) Pub. Date: Feb. 12, 2026

(54) HILL PROTECT POWER OPEN ANGLE ALGORITHM FOR A VEHICLE CLOSURE MEMBER

(71) Applicant: Magna Closures Inc., Newmarket (CA)

(72) Inventor: Ryan Herman, Newmarket (CA)

(73) Assignee: Magna Closures Inc., Newmarket (CA)

(21) Appl. No.: 19/292,477

(22) Filed: Aug. 6, 2025

Related U.S. Application Data
(60) Provisional application No. 63/680,868, filed on Aug. 8, 2024.

(51) Int. Cl. E05F 15/75; B60J 5/04

(52) U.S. Cl. CPC E05F 15/75; B60J 5/047; E05Y 2400/446; E05Y 2900/531

(57) ABSTRACT

A system for controlling motion of a door of a vehicle is provided. The door is moveable between an open position and a closed position. The system includes a power actuator for moving the door and an inclination sensor for detecting at least one of an inclination or a roll of the vehicle. A controller is configured to determine the at least one of the inclination or the roll using the inclination sensor. The controller determines a maximum door open angle of the door based on the at least one of the inclination or the roll whereat the power actuator can move the door toward the closed position and beyond which the power actuator is not able to move the door toward the closed position. The controller is also configured to control movement of the door using the power actuator in view of the maximum door open angle.

### CROSS-REFERENCE TO RELATED APPLICATION

This utility application claims the benefit of U.S. Provisional Application No. 63/680,868 filed Aug. 8, 2024. The entire disclosure of the above application is incorporated herein by reference.

### FIELD

The present disclosure relates closure systems for motor vehicles and, more particularly, to a system including a power actuator for moving a closure member, such as a vehicle door, relative to a vehicle body between an open position and a closed position.

### BACKGROUND

This section provides background information related to the present disclosure which is not necessarily prior art.

Closure members of motor vehicles may be mounted by one or more hinges to the vehicle body. For example, passenger doors may be oriented and attached to the vehicle body by the one or more hinges for swinging movement about a generally vertical pivot axis. In such an arrangement, each door hinge typically includes a door hinge strap connected to the passenger door, a body hinge strap connected to the vehicle body, and a pivot pin arranged to pivotably connect the door hinge strap to the body hinge strap and define the pivot axis. Such swinging passenger doors (“swing doors”) have recognized issues such as, for example, when the vehicle is situated on an inclined surface and the swing door either opens too far or swings shut due to the unbalanced weight of the door. To address this issue, most passenger doors have some type of detent or check mechanism integrated into at least one of the door hinges that functions to inhibit uncontrolled swinging movement of the door by positively locating and holding the door in one or more mid-travel positions in addition to a fully-open position. In some high-end vehicles, the door hinge may include an infinite door check mechanism which allows the door to be opened and held in check at any desired open position. One advantage of passenger doors equipped with door hinges having an infinite door check mechanism is that the door can be located and held in any position to avoid contact with adjacent vehicles or structures.

As a further advancement, power closure member actuation systems have been developed. For passenger doors, like those described above, the power closure member system can function to automatically swing the passenger door about its pivot axis between the open and closed positions, to assist the user as he or she moves the passenger door, and/or to pop out or present the passenger door to the user. Typically, power closure member actuation systems include a power-operated device such as, for example, an electric motor and a rotary-to-linear conversion device that are operable for converting the rotary output of the electric motor into translational movement of an extensible member. In many arrangements, the electric motor and the conversion device are mounted to the passenger door and the distal end of the extensible member is fixedly secured to the vehicle body. One example of a power closure member actuation system for a passenger door is shown in commonly-owned International Publication No. WO2013/013313 to Schuering et al. which discloses use of a rotary-to-linear conversion device or power actuator having an externally-threaded leadscrew rotatively driven by the electric motor and an internally-threaded drive nut meshingly engaged with the leadscrew and to which the extensible member is attached. Accordingly, control over the speed and direction of rotation of the leadscrew results in control over the speed and direction of translational movement of the drive nut and the extensible member for controlling swinging movement of the passenger door between its open and closed positions.

When a vehicle having a powered door drive or power closure member actuation system is on an extreme incline (e.g., San Francisco with nose down condition), there is a door angle beyond which the door if moved past would not be able to be returned to closed position under the actuator power. Thus, there remains a need to develop alternative power closure member actuation systems which address and overcome limitations and drawbacks associated with known power closure member actuation systems as well as to provide increased convenience and enhanced operational capabilities.

### SUMMARY

This section provides a general summary of the present disclosure and is not a comprehensive disclosure of its full scope or all of its features and advantages.

An object of the present disclosure is to provide a system and a method that address and overcome the above-noted shortcomings.

Accordingly, it is an aspect of the present disclosure to provide a system for controlling motion of a door of a vehicle. The door is moveable between an open position and a closed position. The system includes a power actuator configured to move the door between the closed position and open position and between the open position and closed position. The system also includes an inclination sensor configured to detect at least one of an inclination or a roll of the vehicle. A controller is coupled to the power actuator and the inclination sensor and is configured to determine the at least one of the inclination or the roll of the vehicle using the inclination sensor. The controller is additionally configured to determine a maximum door open angle of the door based on the at least one of the inclination or the roll of the vehicle whereat the power actuator can move the door toward the closed position and beyond which the power actuator is no longer able to move the door toward the closed position. The controller is also configured to control movement of the door using the power actuator in view of the maximum door open angle.

In another aspect of the disclosure, an automatic operating zone in which the power actuator can move the door toward the closed position is defined between the closed position and the maximum door open angle. The controller is configured to assist movement of the door by the user toward the closed position using the power actuator in response to the position of the door not being within the automatic operating zone.

In another aspect of the disclosure, an automatic operating zone in which the power actuator can move the door toward the closed position is defined between the closed position and the maximum door open angle. The controller is further configured to move the door toward the closed position using the power actuator with a first force based on a door motion input in response to the position of the door being within the automatic operating zone. The controller is also configured to assist movement of the door by a user toward the closed position using the power actuator with a second force less than the first force based on the door motion input in response to the position of the door not being within the automatic operating zone.

In another aspect of the disclosure, an automatic operating zone in which the power actuator can move the door toward the closed position is defined between the closed position and the maximum door open angle. The controller is further configured to assist movement of the door by a user toward the closed position using the power actuator with an actuator force based on the door motion input in response to the position of the door not being within the automatic operating zone. A force needed to move the door outside the automatic operating zone toward the closed position is equal to a sum of the actuator force and a user force greater than the actuator force.

In another aspect of the disclosure, a size of the power actuator is selected based on no automatic movement of the door to the closed position beyond the maximum door open angle.

In another aspect of the disclosure, the at least one of the inclination or the roll of the vehicle is greater than or equal to 15 degrees.

It is another aspect of the present disclosure to provide a method for controlling motion of a door of a vehicle. The door is moveable between an open position and a closed position. The method includes the step of determining at least one of an inclination or a roll of the vehicle of the vehicle using an inclination sensor. The method additionally includes the step of determining a maximum door open angle of the door based on the at least one of the inclination or the roll of the vehicle whereat a power actuator can move the door and beyond which the power actuator is no longer able to move the door. The method also includes the step of controlling movement of the door using the power actuator in view of the maximum door open angle.

In another aspect of the disclosure, an automatic operating zone in which the power actuator can move the door toward the closed position is defined between the closed position and the maximum door open angle. The method further includes the step of assisting movement of the door by the user toward the closed position using the power actuator in response to the position of the door not being within the automatic operating zone.

In another aspect of the disclosure, an automatic operating zone in which the power actuator can move the door toward the closed position is defined between the closed position and the maximum door open angle. The method further includes the step of moving the door toward the closed position using the power actuator with a first force based on the door motion input in response to the position of the door being within the automatic operating zone. The method also includes the step of assisting movement of the door by a user toward the closed position using the power actuator with a second force less than the first force based on the door motion input in response to the position of the door not being within the automatic operating zone.

In another aspect of the disclosure, an automatic operating zone in which the power actuator can move the door toward the closed position is defined between the closed position and the maximum door open angle. The method further includes the step of assisting movement of the door by a user toward the closed position using the power actuator with an actuator force based on the door motion input in response to the position of the door not being within the automatic operating zone, a force needed to move the door outside the automatic operating zone toward the closed position being equal to a sum of the actuator force and a user force greater than the actuator force.

In another aspect of the disclosure, a size of the power actuator is selected based on no automatic movement of the door to the closed position beyond the maximum door open angle.

In another aspect of the disclosure, the at least one of the inclination or the roll of the vehicle is greater than or equal to 15 degrees.

In accordance with yet another aspect, a system for controlling motion of a door of a vehicle is provided. The door is moveable between an open position and a closed position. The system includes a power actuator configured to move the door between the closed position and open position and between the open position and closed position. The system additionally includes an inclination sensor configured to detect at least one of an inclination or a roll of the vehicle. A controller is coupled to the power actuator and the inclination sensor and is configured to determine the at least one of the inclination or the roll of the vehicle using the inclination sensor. The controller is further configured to determine a maximum door open angle of the door based on the at least one of the inclination or the roll of the vehicle whereat the power actuator can move the door toward the closed position and beyond which the power actuator is no longer able to move the door toward the closed position. The controller is also configured to control movement of the door using the power actuator in an automatic mode to the maximum door open angle, and control movement of the door using the power actuator in a user assist mode past the maximum door open angle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle on an incline and equipped with a system for controlling motion of a door of the vehicle according aspects of the disclosure;

FIG. 2 is a block diagram of the system and illustrates additional details according aspects of the disclosure;

FIG. 3 is a top view of a vehicle and illustrates an example range of movement for the door according aspects of the disclosure;

FIG. 4 is a plot of spindle force of a spindle of an example power actuator versus a door angle or position according aspects of the disclosure;

FIG. 5 is another top view of a vehicle and illustrates an example range of movement for the door including the maximum door open angle as well as movement that can be provided by the power actuator in either a closing direction or an opening direction from the maximum door open angle according aspects of the disclosure;

FIG. 6 is another plot of spindle force of a spindle of the example power actuator versus a door angle or position as shown in FIG. 3 and illustrates an example value of the maximum door open angle of the door according aspects of the disclosure; and

FIGS. 7 and 8 illustrate steps of a method for controlling motion of a door of a vehicle according aspects of the disclosure.

### DETAILED DESCRIPTION

In the following description, details are set forth to provide an understanding of the present disclosure. In some instances, certain circuits, structures and techniques have not been described or shown in detail in order not to obscure the disclosure.

In general, at least one example embodiment of a system and a method in accordance with the teachings of the present disclosure will now be disclosed. The example embodiment is provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are described in detail.

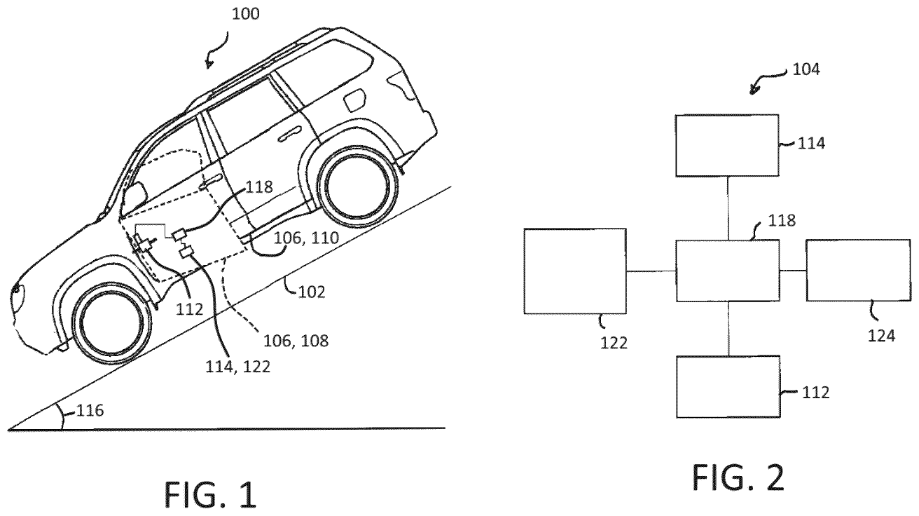

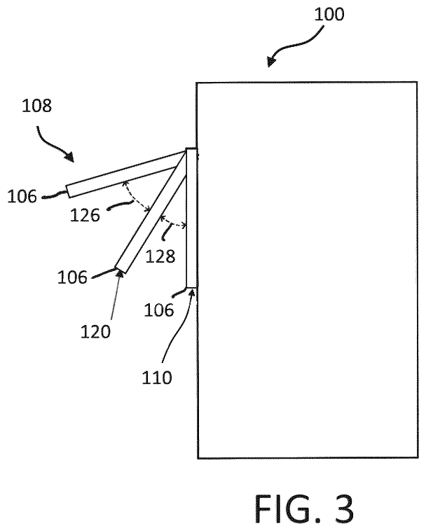

FIG. 1 is a side view of a vehicle 100 on an inclined surface 102 and equipped with a system 104 for controlling motion of a door 106 of the vehicle 100. As shown in dashed lines in FIG. 1 specifically, the door 106 is moveable between an open position 108 and a closed position 110. FIG. 2 is a block diagram of the system 104 and illustrates additional details. Referring to both FIGS. 1 and 2, the system 104 includes a power actuator 112 configured to move the door 106 between the closed position 110 and open position 108 and between the open position 108 and closed position 110 (i.e., in both an opening direction and a closing direction). The system 104 also includes an inclination sensor 114 configured to detect at least one of a pitch or an inclination (e.g., angle 116 of FIG. 1 or an amount of deviation from a completely horizontal orientation of the vehicle 100 longitudinally or along a length of the vehicle 100 from front to back) or a roll of the vehicle 100 (i.e., amount of deviation from a completely horizontal orientation of the vehicle 100 laterally or along a width of the vehicle 100 from side to side). According to an aspect, the at least one of the inclination or the roll of the vehicle 100 is greater than or equal to 15 degrees. The system 104 also includes a controller 118 coupled to the power actuator 112 and the inclination sensor 114.

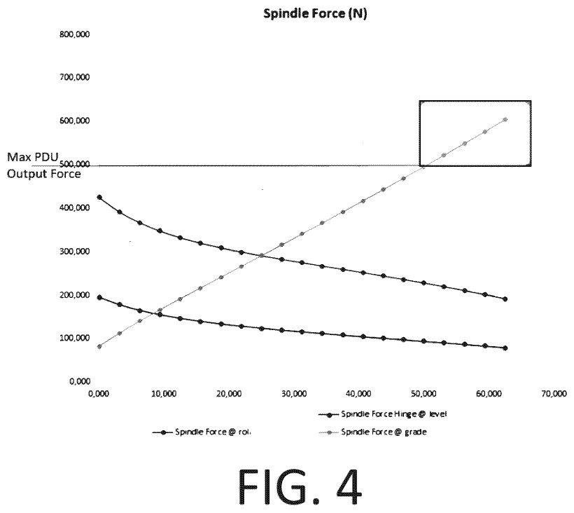

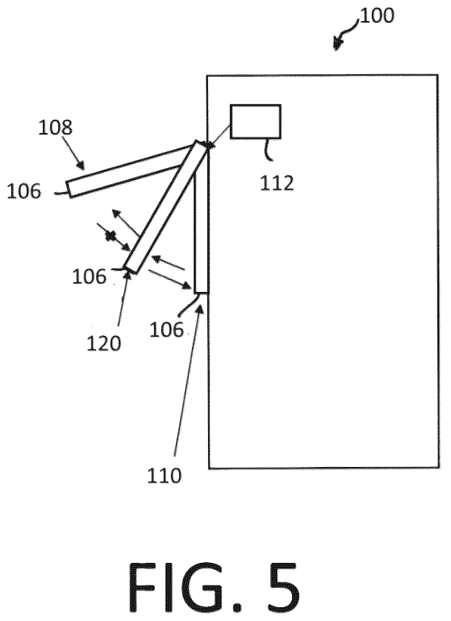

FIG. 3 is a top view of a vehicle 100 and illustrates an example range of movement for the door 106. It is possible that gravity influence on a door 106 may cause resulting kinematic load on the power actuator 112 that exceeds a maximum output force in a given power actuator 112 design. FIG. 4 is a plot of spindle force of a spindle of an example power actuator 112 versus a door angle or position. Output force curves at various pitch/roll combinations along with the maximum output force of an example power actuator 112 are shown. The highlighted area above the maximum power actuator output force of the power actuator 112 (PDU) indicates angles where the power actuator 112 does not generate enough force to move the door 106. FIG. 5 is another top view of a vehicle 100 and illustrates an example range of movement for the door 106 as well as movement that can be provided by the power actuator 112 in either a closing direction or an opening direction from a maximum door open angle 120. One solution is to redesign the gear train to create more output torque. However, this may not always be possible due to packaging size or cost.

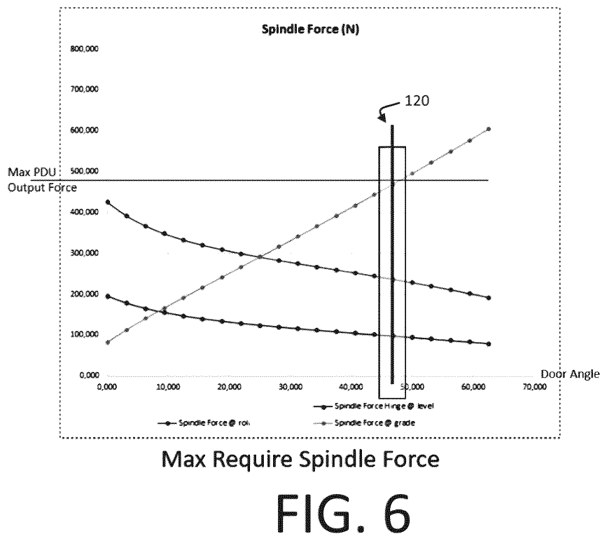

FIG. 6 is another plot of spindle force of a spindle of the example power actuator 112 versus a door angle or position as shown in FIG. 3 and illustrates an example value of the maximum door open angle 120 of the door 106. The value of the maximum door open angle 120 may be determined for each inclination or grade/roll combination. So, for the maximum door open angle 120, an operating boundary zone can be defined. Such an operating boundary zone can be predetermined empirically or theoretically if a virtual system twin is available. The boundary zone would include the maximum door open angle 120 allowed for each pitch and roll combination of the vehicle 100 for a given power actuator 112. The orientation of the vehicle 100 can be determined before starting door 106 motion. So, the controller 118 is configured to determine the at least one of the inclination or the roll of the vehicle 100 using the inclination sensor 114. Based on this determined orientation the maximum door open angle 120 is determined. Thus, the controller 118 is additionally configured to determine a maximum door open angle 120 of the door 106 based on the at least one of the inclination or the roll of the vehicle 100 whereat the power actuator 112 can move the door 106 toward the closed position 110 and beyond which the power actuator 112 is no longer able to move the door 106 toward the closed position 110. Accordingly, the controller 118 is also configured to control movement of the door 106 using the power actuator 112 in view of the maximum door open angle 120. So, such a control strategy will determine the maximum door open angle 120 which the power actuator 112 can move the door 106 when there is an incline, so as to be able to return the door 106 to closed position 110 under power. For example, the power actuator 112 can move the door 106 with the door 106 on a incline/roll, up until the maximum door angle at which angle the door 106 may be controlled to be stopped at this angle e.g. via a separated mechanical door check device or by the power of the power actuator 112 as part of an infinite check function e.g. power hold. Up until this angle, the door 106 is controlled under an automatic mode of the power actuator 112 not requiring the assistance of the user to move the door 106 e.g. the powered actuator 112 is capable of moving the door without external user assistance. Therefore, an automatic open mode may only open the door 106 to this newly defined maximum door open angle 120. Beyond this maximum door angle, the door 106 can be moved with assistance of the user during a user assist mode whereat the user assists with the supplementing the output force of the powered actuator 112 required to move the door 106 e.g. without which the powered actuator would be unable to move the door 106 against. For example, the power actuator 112 may be powered at its maximum output force such that together with a user applied force to the door, the door motion can be continued past the maximum door opening angle towards a fully opened position. Alternatively, the powered actuator 106 may be operated in a braking mode to resist the effect of gravity while allowing the door to move to a position beyond the maximum door angle. Similarly, to return the door 106 from the fully opened position back to the maximum door opening angle, the power actuator 112 may be powered at its maximum output force such that together with a user applied force to the door 106, the door 106 can be moved against the incline during a manual user assist move until the door 106 reaches the maximum door angle whereat the powered actuator may solely be capable of moving the door as the door 106 returns to an automatic door mode. In other possible words past the maximum door angle 106, the door may be allowed to be moved to an open position, and the powered actuator 112 may be controlled to return to door towards the maximum door open angle with the user assisting the powered actuator 112 e.g. the user provides the supplemental force required to move the door 106 when the powered actuator 112 is not capable of moving the door against the effect of the inclination. As a result, the powered actuator 112 may be selected having an output power rating that meets the majority of door opening conditions while not preventing a door opening or closing for the extreme inclinations for that which the powered actuator 112 is underpowered to perform. A smaller and lower cost actuator 112 may be therefore selected without complete disablement of the powered motion functioning, providing the user with powered convenience in all inclinations.

The techniques described herein will allow partial performance of the system 104 in all conditions. Where the door 106 stops at a partial open angle, the operator or user will be required to open the door 106 further (if required). For closing the door 106, the user would need to manually move the door 106 into a zone where the close function commences and automatic close resumes. So, according to an aspect of the disclosure and still referring to FIGS. 1 and 2, the system 104 includes at least one closure member feedback sensor 122 (e.g., a direct position sensor for the door 106 or indirect via monitoring Hall counts of a motor of the power actuator 112) configured to detect at least one of a position of the door 106 or a speed of the door 106. Thus, the controller 118 is further configured to detect a door motion input 124 (FIG. 2) by a user for automatic movement of the door 106 toward the open position 108 (or in other situations toward the closed position) in an automatic mode. The controller 118 is additionally configured, using the power actuator 112, to move the door 106 to the maximum door open angle 120 as detected by the at least one closure member feedback sensor 122.

According to further aspects of the disclosure, the controller 118 is further configured to monitor manual movement of the door 106 by the user beyond the maximum door open angle 120 using the at least one closure member feedback sensor 122. Such a range is indicated in FIG. 3 as numeral 126. The controller 118 resumes automatic movement of the door 106 toward the closed position 110 in response to detecting the position of the door 106 is at the maximum door open angle 120.

Referring back to FIG. 3, an automatic operating zone 128 in which the power actuator 112 can move the door 106 toward the closed position 110 is defined between the closed position 110 and the maximum door open angle 120. Thus, according to an aspect, the controller 118 is configured to automatically move the door 106 toward the closed position 110 using the power actuator 112 based on the door motion input 124 in response to the position of the door 106 being within the automatic operating zone 128 and not automatically move the door 106 toward the closed position 110 using the power actuator 112 in response to the position of the door 106 not being within the automatic operating zone 128. In other words, to prevent situations in which the power actuator 112 cannot move the door 106 toward the closed position 110, automatic control of the movement of the door 106 can be limited to always remain within the automatic operating zone 128 or operating angle range where the power actuator 112 does have enough torque to properly control the door 106.

Furthermore, the power actuator 112 can still provide power assist and infinite beyond the modified stop position (i.e., maximum door open angle 120) as the force required for power assist and hold are much less than for automatic movement. Thus, according to an aspect, the controller 118 is further configured to assist movement of the door 106 by the user using the power actuator 112 and hold the door 106 at door check positions outside the automatic operating zone 128. When the door 106 is held for a time period exceeding motor thermal protect time, the door 106 may, for example, slowly move to a neutral position in many systems, which, at a high pitch angle, would be full open or full closed position 110 anyway. So, according to another aspect, the controller 118 is configured to assist movement of the door 106 by the user toward the closed position 110 using the power actuator 112 in response to the position of the door 106 not being within the automatic operating zone 128. Therefore, powered function of the door 106 can only be improved though implementation of the techniques described herein. According to an aspect, a size of the power actuator 112 is selected based on no automatic movement of the door 106 to the closed position 110 beyond the maximum door open angle 120. Thus, a smaller power actuator 112 (e.g., less robust gearing, less robust electronics, lower current) which would be sufficient to handle motion of the door 106 in the majority of situations (e.g., inclination and/or roll of less than 15 degrees), while the more rare cases of increased roll or inclination, the power actuator 112 can move the door 106 with the assistance of a user.

More specifically, according to other aspects, the controller 118 is further configured to move the door 106 toward the closed position 110 using the power actuator 112 with a first force based on the door motion input 124 in response to the position of the door 106 being within the automatic operating zone 128. The controller 118 is also configured to assist movement of the door 106 by the user toward the closed position 110 using the power actuator 112 with a second force less than the first force based on the door motion input 124 in response to the position of the door 106 not being within the automatic operating zone 128.

According to other aspects, the controller 118 is further configured to assist movement of the door 106 by the user toward the closed position 110 using the power actuator 112 with an actuator force based on the door motion input 124 in response to the position of the door 106 not being within the automatic operating zone 128. A force needed to move the door 106 outside the automatic operating zone 128 toward the closed position 110 may be equal to a sum of the actuator force and a user force greater than the actuator force. So, the controller 118 can go from a mode/angle where the power actuator 112 causes the motion of the door 106 using all its power, to a mode where the power actuator 112 supplements the force of the user moving the door 106. In this last mode, the user may be supplementing the force of the power actuator 112, which is different from the haptic or automatic mode in which the power actuator 112 supplements the user's input force (i.e., user input force) in haptic mode and an automatic mode where the user does not require to push or pull on the door during the power actuator 112 moving the door 106. Accordingly, the user may have to put in a large portion of the power to move the door 106.

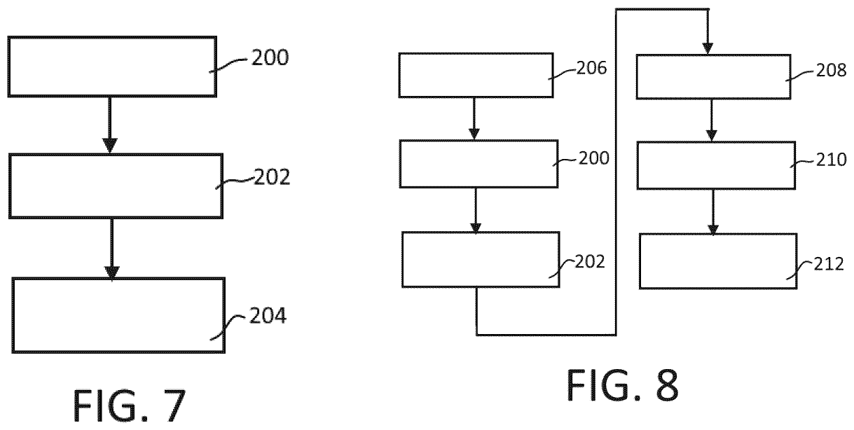

FIGS. 7 and 8 illustrate steps of a method for controlling motion of a door 106 of a vehicle 100. Again, the door 106 is moveable between an open position 108 and a closed position 110. Referring specifically to FIG. 7, the method includes the step of 200 determining at least one of an inclination or a roll of the vehicle 100 of the vehicle 100 using an inclination sensor 114. As discussed above and according to an aspect, the at least one of the inclination or the roll of the vehicle 100 is greater than or equal to 15 degrees. The method continues with the step of 202 determining a maximum door open angle 120 of the door 106 based on the at least one of the inclination or the roll of the vehicle 100 whereat a power actuator 112 can move the door 106 toward the closed position 110 and beyond which the power actuator 112 is no longer able to move the door 106 toward the closed position 110. The method also includes the step of 204 controlling movement of the door 106 using the power actuator 112 in view of the maximum door open angle 120.

Next, referring specifically to FIG. 8 and according to additional aspects of the disclosure, the method can also include the step of 206 detecting a door motion input 124 by a user for automatic movement of the door 106 toward the open position 108. The method may additionally include, 208 using the power actuator 112, moving the door 106 to the maximum door open angle 120 as detected by at least one closure member feedback sensor 122 configured to detect at least one of a position of the door 106 or a speed of the door 106. The method may further include the step of 210 monitoring manual movement of the door 106 by the user beyond the maximum door open angle 120 using the at least one closure member feedback sensor 122. The method can also include the step of 212 resuming automatic movement of the door 106 toward the closed position 110 in response to detecting the position of the door 106 is at the maximum door open angle 120.

Again, referring back to FIG. 3, an automatic operating zone 128 in which the power actuator 112 can move the door 106 toward the closed position 110 is defined between the closed position 110 and the maximum door open angle 120. So according to another aspect, the method further includes the steps of automatically moving the door 106 toward the closed position 110 using the power actuator 112 based on the door motion input 124 in response to the position of the door 106 being within the automatic operating zone 128 and not automatically moving the door 106 toward the closed position 110 using the power actuator 112 in response to the position of the door 106 not being within the automatic operating zone 128.

According to other aspects, the method may also include the step of assisting movement of the door 106 by the user using the power actuator 112 and hold the door 106 at door check positions outside the automatic operating zone 128.

According to an additional aspect, the method further includes the step of assisting movement of the door 106 by the user toward the closed position 110 using the power actuator 112 in response to the position of the door 106 not being within the automatic operating zone 128. As discussed and according to an aspect, the size of the power actuator 112 is selected based on no automatic movement of the door 106 to the closed position 110 beyond the maximum door open angle 120.

According to other aspects, the method further includes the step of moving the door 106 toward the closed position 110 using the power actuator with a first force based on the door motion input 124 in response to the position of the door 106 being within the automatic operating zone 128. The method also includes the step of assisting movement of the door 106 by the user toward the closed position 110 using the power actuator 112 with a second force less than the first force based on the door motion input 124 in response to the position of the door 106 not being within the automatic operating zone 128.

According to another aspect, the method further includes the step of assisting movement of the door 106 by the user toward the closed position 110 using the power actuator 112 with an actuator force based on the door motion input 124 in response to the position of the door 106 not being within the automatic operating zone 128. Again, the force needed to move the door 106 outside the automatic operating zone 128 toward the closed position 110 may be equal to the sum of the actuator force and a user force greater than the actuator force.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A system for controlling motion of a door of a vehicle, the door moveable between an open position and a closed position, the system comprising:
a power actuator configured to move the door between the closed position and open position and between the open position and closed position;
an inclination sensor configured to detect at least one of an inclination or a roll of the vehicle; and
a controller coupled to the power actuator and the inclination sensor and configured to:
determine the at least one of the inclination or the roll of the vehicle using the inclination sensor,
determine a maximum door open angle of the door based on the at least one of the inclination or the roll of the vehicle whereat the power actuator can move the door toward the closed position and beyond which the power actuator is no longer able to move the door toward the closed position, and
control movement of the door using the power actuator in view of the maximum door open angle.

2. The system as set forth in claim 1, further including at least one closure member feedback sensor configured to detect at least one of a position of the door or a speed of the door and wherein the controller is further configured to:
detect a door motion input by a user for automatic movement of the door toward the open position; and
using the power actuator, move the door to the maximum door open angle as detected by the at least one closure member feedback sensor.

3. The system as set forth in claim 2, wherein the controller is further configured to:
monitor manual movement of the door by the user beyond the maximum door open angle using the at least one closure member feedback sensor; and
resume automatic movement of the door toward the closed position in response to detecting the position of the door is at the maximum door open angle.

4. The system as set forth in claim 2, wherein an automatic operating zone in which the power actuator can move the door toward the closed position is defined between the closed position and the maximum door open angle, and the controller is configured to automatically move the door toward the closed position using the power actuator based on the door motion input in response to the position of the door being within the automatic operating zone and not automatically move the door toward the closed position using the power actuator in response to the position of the door not being within the automatic operating zone.

5. The system as set forth in claim 4, wherein the controller is further configured to assist movement of the door by the user using the power actuator and hold the door at door check positions outside the automatic operating zone.

6. The system as set forth in claim 2, wherein an automatic operating zone in which the power actuator can move the door toward the closed position is defined between the closed position and the maximum door open angle, and the controller is configured to assist movement of the door by the user toward the closed position using the power actuator in response to the position of the door not being within the automatic operating zone.

7. The system as set forth in claim 1, wherein an automatic operating zone in which the power actuator can move the door toward the closed position is defined between the closed position and the maximum door open angle, and the controller is further configured to:
move the door toward the closed position using the power actuator with a first force based on a door motion input in response to the position of the door being within the automatic operating zone; and
assist movement of the door by a user toward the closed position using the power actuator with a second force less than the first force based on the door motion input in response to the position of the door not being within the automatic operating zone.

8. The system as set forth in claim 1, wherein an automatic operating zone in which the power actuator can move the door toward the closed position is defined between the closed position and the maximum door open angle, the controller is further configured to assist movement of the door by a user toward the closed position using the power actuator with an actuator force based on the door motion input in response to the position of the door not being within the automatic operating zone, a force needed to move the door outside the automatic operating zone toward the closed position being equal to a sum of the actuator force and a user force greater than the actuator force.

9. The system as set forth in claim 1, wherein a size of the power actuator is selected based on no automatic movement of the door to the closed position beyond the maximum door open angle.

10. The system as set forth in claim 1, wherein the at least one of the inclination or the roll of the vehicle is greater than or equal to 15 degrees.

11. A method for controlling motion of a door of a vehicle, the door moveable between an open position and a closed position, the method comprising:
determining at least one of an inclination or a roll of the vehicle of the vehicle using an inclination sensor;
determining a maximum door open angle of the door based on the at least one of the inclination or the roll of the vehicle whereat a power actuator can move the door and beyond which the power actuator is no longer able to move the door; and
controlling movement of the door using the power actuator in view of the maximum door open angle.

12. The method as set forth in claim 11, further including the steps of:
detecting a door motion input by a user for automatic movement of the door toward the open position; and
using the power actuator, moving the door to the maximum door open angle as detected by at least one closure member feedback sensor configured to detect at least one of a position of the door or a speed of the door.

13. The method as set forth in claim 12, further including the steps of:
monitoring manual movement of the door by the user beyond the maximum door open angle using the at least one closure member feedback sensor; and
resuming automatic movement of the door toward the closed position in response to detecting the position of the door is at the maximum door open angle.

14. The method as set forth in claim 12, wherein an automatic operating zone in which the power actuator can move the door toward the closed position is defined between the closed position and the maximum door open angle, and the method further includes the steps of automatically moving the door toward the closed position using the power actuator based on the door motion input in response to the position of the door being within the automatic operating zone and not automatically moving the door toward the closed position using the power actuator in response to the position of the door not being within the automatic operating zone.

15. The method as set forth in claim 14, further including the step of assisting movement of the door by the user using the power actuator and hold the door 106 at door check positions outside the automatic operating zone.

16. The method as set forth in claim 12, wherein an automatic operating zone in which the power actuator can move the door toward the closed position is defined between the closed position and the maximum door open angle, and the method further includes the step of assisting movement of the door by the user toward the closed position using the power actuator in response to the position of the door not being within the automatic operating zone.

17. The method as set forth in claim 11, wherein an automatic operating zone in which the power actuator can move the door toward the closed position is defined between the closed position and the maximum door open angle, the method further including the steps of:
moving the door toward the closed position using the power actuator with a first force based on the door motion input in response to the position of the door being within the automatic operating zone; and
assisting movement of the door by a user toward the closed position using the power actuator with a second force less than the first force based on the door motion input in response to the position of the door not being within the automatic operating zone.

18. The method as set forth in claim 11, wherein an automatic operating zone in which the power actuator can move the door toward the closed position is defined between the closed position and the maximum door open angle, the method further including the step of assisting movement of the door by a user toward the closed position using the power actuator with an actuator force based on the door motion input in response to the position of the door not being within the automatic operating zone, a force needed to move the door outside the automatic operating zone toward the closed position being equal to a sum of the actuator force and a user force greater than the actuator force.

19. The method as set forth in claim 11, wherein a size of the power actuator is selected based on no automatic movement of the door to the closed position beyond the maximum door open angle.

20. A system for controlling motion of a door of a vehicle, the door moveable between an open position and a closed position, the system comprising:
a power actuator configured to move the door between the closed position and open position and between the open position and closed position;
an inclination sensor configured to detect at least one of an inclination or a roll of the vehicle; and
a controller coupled to the power actuator and the inclination sensor and configured to:
determine the at least one of the inclination or the roll of the vehicle using the inclination sensor,
determine a maximum door open angle of the door based on the at least one of the inclination or the roll of the vehicle whereat the power actuator can move the door toward the closed position and beyond which the power actuator is no longer able to move the door toward the closed position,
control movement of the door using the power actuator in an automatic mode to the maximum door open angle, and
control movement of the door using the power actuator in a user assist mode past the maximum door open angle.
